(19) United States
(12) Patent Application Publication
(10) Pub. No.: US 2023/0033807 A1
(43) Pub. Date: Feb. 2, 2023

(54) A LID

(71) Applicant: HANPAK LIMITED, Laois (IE)

(72) Inventor: Wei LU, Dublin (IE)

(21) Appl. No.: 17/790,817

(22) PCT Filed: Jan. 5, 2021
(86) PCT No.: PCT/EP2021/050097

§ 371 Date: Jul. 5, 2022

(30) Foreign Application Priority Data
Jan. 6, 2020 (IE) S2020/0003
Jun. 15, 2020 (IE) S2020/0126

(51) Int. Cl. A47G 19/22; B65D 43/02

(52) U.S. Cl. CPC A47G 19/2272; B65D 43/0202; B65D 2543/00046; B65D 2543/00296

(57) ABSTRACT

An anti-splash sip-through lid for a beverage container, such as, for example, but not limited thereto, a disposable lid for a disposable drinking cup, or a re-usable lid for a re-usable drinking cup, for hot and/or cold drinks, e.g. coffee, tea, soda, beer, etc. In examples, the lid includes an outer side, an inner side and a rim; a drinking aperture (7) formed in the lid; and a flow deflector arrangement (9) adjacent to the drinking aperture, wherein the lid or parts thereof are formed from sheet material. In other examples, the lid includes an outer side, an inner side and a rim; a drinking aperture formed in the lid; and a flow deflector arrangement adjacent to the drinking aperture, wherein the lid comprises a first flap (27) formed in the lid and initially blocking the drinking aperture.

### FIELD OF THE INVENTION

The present invention relates to an anti-splash sip-through lid for a beverage container, such as, for example, but not limited thereto, a disposable lid for a disposable drinking cup, or a re-usable lid for a re-usable drinking cup, for hot and/or cold drinks, e.g. coffee, tea, soda, beer, etc.

### BACKGROUND TO THE INVENTION

Sip-through disposable lids for single-use disposable and re-usable beverage cups are well known. These lids are generally moulded from plastic. Plastic disposable lids are not environmentally friendly. Paper or cardboard lids can be made from renewable materials that are biodegradable and recyclable and are therefore more environmentally friendly than plastic lids. Paper lids made from sheet paperboard are typically known to be used on single-use soup containers but not on drinking cups. Recently paper lids with basic functionality and features began to be used on drinking cups. Drinking apertures on current paper lids usually comprise pre-made apertures which may be closed off by a piece of film which needs to be peeled off. Alternatively, the lid surface may include a serrated section in the shape of the intended aperture so that the aperture is formed by pulling or pushing open the serration, this serrated section may be folded back into the closed position to reseal the cup when not in use. Alternatively, permanently open apertures may be provided. Once opened, these arrangements are prone to spills and splashes as there is nothing to stop the liquid from rushing up towards the aperture if the liquid is disturbed however slightly during transportation. Some plastic disposable lids, e.g. as described in US 2010/0163568 A1 (Mucci et al), are equipped with a valve or a spout to reduce the possibility of spills or splashes. Such valves can be easily moulded integrally with the plastic lid. However, due to the nature of paper material, such valves cannot be incorporated into paper lids.

WO2017/051162 discloses an intricate lid made from moulded plastics or similar mouldable material, the lid having a flange portion for connecting the lid to a container and at least one drinking aperture and a baffle attached to the perimeter of said at least one drinking aperture.

US2014/299614 discloses an intricate and complex moulded lid having a peripheral rim for engaging a drinking vessel, and a drinking spout having a spout front wall extending upwardly from the peripheral rim and a spout top wall connected to the front wall, and a dispensing well formed within the spout top wall, the dispensing well having a front wall and a bottom wall. The spout and dispensing well are configured for allowing consumption of a beverage contained within a vessel. The dispensing well bottom wall is closed to block direct line of sight pathways for beverage in the drinking vessel. An opening in the front wall of the dispensing well allows beverage to flow from the interior of the vessel through said dispensing well, with at least one baffle surrounding the opening in the front wall of the dispensing well serves as a splash deflector and provides a fluid channel path between interior of the drinking vessel and the opening.

US 2016/0198876 discloses a similar intricate and complex moulded lid, but where the raised drinking spout is located proximal the peripheral rim.

US2016/0198875 also discloses a similar intricate and complex moulded lid, but where the drinking spout extends upwardly from the lid, and the dispensing well is formed within the drinking spout, with a splash barrier provided at the bottom of the dispensing well. The opening to allow beverage to flow from the interior of the vessel into the dispensing well is formed in the side of said dispensing well. A plurality of baffles are located on at least one internal surface of the drinking spout, with at least one baffle located at each side of the splash barrier. The lid further includes a lid insert fixed within the interior of the drinking spout which provides a channel beneath said lid insert through which the beverage can flow horizontally from the interior of the drinking vessel into the dispensing well.

Related variants of similar intricate and complex moulded lids are disclosed in US2010/071790.

Accordingly, an object of the present invention is to provide an improved lid for a beverage container which efficiently prevents splashes and reduces the scale, intensity or extent of spills, is easy to use and relatively easy and inexpensive to manufacture compared with prior art lids. Such lids also facilitate the cup and lid being made from the same material, thereby avoiding mixed materials and facilitating the easy disposal after use of the cup and lid combination into a single recycling or other environmentally friendly waste disposal and/or recovery channel.

### SUMMARY OF THE INVENTION

Accordingly, in one aspect of the invention there is provided a lid for a beverage container, the lid comprising:
an outer side and an inner side and a rim;
a drinking aperture formed in the lid; and
a flow deflector arrangement adjacent to the drinking aperture, wherein the lid, or individual parts thereof, is formed from sheet material.

Optionally, the sheet material is foldable sheet material.

Optionally, the sheet material is paperboard.

Optionally, the lid is made from a recyclable, biodegradable or compostable material, such as, but not limited to, paper pulp, paperboard, cardboard, vegetable starch or other suitable plant-based material.

Optionally, the flow deflector arrangement is configured to prevent liquid contained in the beverage container from splashing directly upwardly through the drinking aperture when the beverage container is in a generally upright orientation.

Optionally, the flow deflector arrangement is configured to allow the liquid to approach the drinking aperture sideways.

Optionally, the lid comprises a first flap formed in the lid and initially blocking the drinking aperture. That is, the first flap is defined by the material of the lid that is cut to form the drinking aperture.

Optionally, in examples, the aperture is formed by complete removal of a portion of the lid material that would otherwise form a flap.

The application of this invention may extend beyond paper lids, including to lids made from plastic and other materials. Thus, alternatively, e.g. the lid may be made from PET plastic for use with recyclable PET plastic cups or paper cups. Alternatively, other materials may be used.

Accordingly, in a second aspect of the invention, there is provided a lid for a beverage container, the lid comprising:
an outer side, an inner side and a rim;
a drinking aperture formed in the lid; and

a flow deflector arrangement adjacent to the drinking aperture,
wherein the lid comprises a first flap formed in the lid and initially blocking the drinking aperture.

Optionally, the first flap is defined by the material of the lid that is cut to form the drinking aperture.

Optionally, the lid of the second aspect is made from recyclable, biodegradable or compostable material, such as paper pulp, paperboard, cardboard, vegetable starch or other suitable plant-based material.

Optionally, the lid of the second aspect is made from recyclable plastics material.

Optionally, the recyclable plastics material is polyethylene terephthalate (PET).

In a third aspect of the invention there is provided a lid for a beverage container, the lid comprising:
an outer side and an inner side and a rim;
a drinking aperture formed in the lid; and
a flow deflector arrangement at the inner side of the lid adjacent to the drinking aperture;
wherein the flow deflector arrangement is sized and shaped to fit snugly against the wall of the beverage container.

Advantageously, this arrangement imparts extra rigidity onto the lid/beverage container assembly and makes the beverage container safer to handle. For example, a suitable shield panel may be shaped to match closely the shape in plane of the wall of the beverage container at a level where the flow deflector arrangement is located inside the beverage container when the lid is placed on the beverage container. The flow deflector arrangement may also be of a different shape to the rim of the container, for example the flow deflector arrangement may be oval shaped where the container rim is circular. In such instances, when the lid closes the beverage container, the flow deflector arrangement causes the wall of the beverage container to deform (in the case where the material of the beverage container is capable of being deformed by the flow deflector arrangement) and to assume the shape of the flow deflector arrangement thereby increasing the rigidity of the lid/beverage container assembly. Simultaneously with imparting rigidity onto the lid/beverage container assembly, the snug fit of the flow deflector arrangement sealingly secures the lid to the beverage container so that the lid is held securely on the beverage container whilst also preventing leaks.

Benefits of this aspect of the invention compared to existing lid/cup combinations include that the combined unit is more streamlined; more solid and secure for holding; easier and more secure to fit the lid to the cup; and the lid is less prone to pop off or be accidentally knocked off the cup.

It will be understood that the following optional features and possible arrangements are applicable to each of the first, second and third aspects of the invention. Accordingly, the wording ‘In one arrangement’ should not be construed as applicable to any one aspect of the invention but rather can be applied to any or all aspects equally.

Optionally, the drinking aperture lies planar with the surrounding lid surface.

Optionally, the flow deflector arrangement is separate from the drinking aperture, i.e. the flow deflector does not form part of the drinking aperture, and vice versa.

The rim may be annular, oval shaped or of another suitable shape.

The lid can be adapted to be sealingly fastened to the container. In some modifications, the lid can be adapted to be fastened to the external wall of the container. In other modifications, the lid can be adapted to be fastened to the internal wall of the container. In further modifications, the lid can be adapted to be fastened to a rim at a top opening of the container.

In one arrangement, the flow deflector arrangement is preferably configured to prevent liquid contained in the beverage container, especially watery liquid prone to splashing, from splashing directly upwardly through the drinking aperture when the beverage container is in a generally upright orientation. The flow deflector arrangement is further preferably configured to allow the liquid to approach the drinking aperture sideways or indirectly so that the liquid loses much of its energy/momentum by the time it reaches the drinking aperture, thereby reducing the possibility and intensity of unexpected spills or splashes when drinking or pouring from the container. In one arrangement, the flow deflector arrangement comprises a portion arranged substantially in front of the drinking aperture to deflect splashing liquid or to prevent it from flowing directly into the drinking aperture. The flow deflector arrangement is preferably arranged on the inner side of the lid so as, together with the inner side of the lid, to define a flow opening facing sideways relative to the inner side of the lid, i.e. towards a wall of the beverage container when the lid is in use. The plane of the flow opening may be substantially perpendicular to or oriented at an angle relative to the inner side of the lid. Thus, in use, when the beverage container is in a generally upright orientation, the flow deflector arrangement prevents splashes from moving directly into the drinking aperture. When the user tilts the container in order to sip the liquid, the liquid first encounters the flow deflector and then approaches the drinking aperture through the flow opening defined underneath the lid by the flow deflector arrangement and the inner side of the lid. In this manner, the liquid loses much of its energy/momentum by first encountering the flow deflector arrangement thereby providing for smoother flow through the drinking aperture during sipping. If the container is knocked over, the rate and intensity of spill and the extent of splashing may also be limited.

In one arrangement, the lid may comprise a first flap formed in the lid and initially blocking the drinking aperture. In one arrangement, the first flap is movable between open and closed positions. The flap is preferably movable between open and closed positions about a hinge. In the closed position the first flap is positioned across the drinking aperture and in the open position the flap is positioned perpendicular to or at an angle in relation of the plane of the drinking aperture. One open position of the first flap may be achieved by pushing the first flap downwardly in the direction from the outer side of the lid towards the inner side of the lid. Another open position of the first flap may be achieved by pulling the first flap upwardly in the direction from the inner side of the lid towards the outer side of the lid. A suitable gripping arrangement, e.g. a pulling tab made from a suitable material, e.g. paper or starch, may be provided on the first flap for pulling the first flap upwardly. The first flap may be formed, for example, by cutting a shape of the first flap in the lid whilst leaving a portion of the flap shape attached to the lid so that the uncut material forms a hinge about which the flap can move between open and closed positions. In a variation, the first flap may have a cut out or an aperture defined in the first flap to (1) allow the first flap to be lifted and (2) to permit drinking without the need for the first flap to be moved into the open position. In this arrangement, the first flap can still be moved into the open position for an enhanced flow.

In an alternative arrangement, the lid may comprise a weakened area, provided by, for example, perforations or thinning of the lid material, the weakened area defining the flap and allowing the flap to be torn off in order to open the drinking aperture and to allow drinking from the container, while until opened, the lid, together with the flap, provide a fully sealed closure.

In one arrangement, the flow deflector arrangement may comprise a panel provided on the inner side of the lid underneath the first flap or on the outer side of the lid over the first flap, the panel having a second flap formed in the panel and the second flap being movable between open and closed positions. In the closed position, the second flap is oriented across the drinking aperture and in the open position the second flap is positioned perpendicular to or at an angle in relation of the plane of the drinking aperture. The first and second flaps are preferably superimposed so that when the upper one of the first and second flaps is pushed through the drinking aperture, the lower one of the first and second flaps is also pushed by the upper flap into the open position. When both the first and the second flaps have been pushed downwardly into the open position, the first and second flaps remain engaged and thereby, on the one hand, form a shield adjacent to the drinking aperture and, on the other hand, together with the inner side of the lid, define the flow opening. Each of the first and second flaps may have cooperating engaging elements, such as, for example, teeth or suitably formed cooperating protrusions, configured to engage when the first and second flaps have been pushed into the open position and to prevent the first and second flaps from moving back into the closed position. During drinking, when the beverage container is tilted, liquid flows between the wall of the beverage container and the shield formed by the first and second flaps into the flow opening and towards the drinking aperture and is guided into the aperture by the wall of the beverage container. When the beverage container is in the upright position, the shield prevents splashes from reaching the drinking aperture.

In another arrangement, the flow deflector arrangement comprises a permanent shield of suitable shape and size formed on the inner side of the lid. For example only, the permanent shield may be provided as an elongated trough attached to the inner side of the lid. The trough may have at least one open end adjacent the drinking aperture and in use facing the wall of the container so as to define the flow opening together with the inner side of the lid. The trough may have a uniform width. Alternatively, the trough may have walls converging in the direction away from the open end and towards the inner side of the lid. The first flap may be provided in this arrangement. The first flap can be either opened outwardly or downwardly. Upon being pushed downwardly through the drinking aperture, the first flap may form part of the shield. During drinking, when the beverage container is tilted, liquid flows between the wall of the beverage container and the permanent shield into the flow opening and towards the drinking aperture. When the beverage container is in the upright position, the permanent shield prevents splashes from reaching the drinking aperture.

In yet another arrangement, the flow deflector arrangement comprises a pop up shield of suitable shape and size formed on the inner side of the lid across the drinking aperture. The pop up shield may be folded prior to use. The first flap may be provided in this arrangement. The pop up shield may be unfolded by pushing the first flap downwardly through the drinking aperture and thereby expanding the pop up shield. Upon being pushed downwardly through the drinking aperture, the first flap may form part of the shield. In the expanded state the pop up shield may have the same size and shape as the permanent shield described above. During drinking, when the beverage container is tilted, liquid flows between the wall of the beverage container and the pop up shield into the flow opening and towards the drinking aperture. When the beverage container is in the upright position, the pop up shield prevents splashes from reaching the drinking aperture.

In a further arrangement, the flow deflector arrangement comprises a filter shield made from a liquid pervious material and arranged on the inner side of the lid across the drinking aperture, the liquid pervious material comprising pores sufficiently fine to reduce or minimise splashes, but capable of allowing liquid to flow through the drinking aperture during drinking. The liquid pervious material may be any type of suitable material which is capable of allowing liquid to pass through but preventing solid particles which may be dispersed in the liquid from passing through it. For example only and without any limitation, the liquid pervious material may comprise a woven, knit, or knotted material of open texture, such as a piece of mesh or fabric, a non-woven material, such as filter paper or non-woven fabric, e.g. made from cellulose or chemical fibres, or a porous article, such as, for example, pierced film, non-woven, e.g. extruded mesh. The filter shield preferably has a portion downwardly spaced from the drinking aperture (i.e. away from the inner side of the lid) and peripheral portions by which the filter shield is attached to the inner side of the lid, preferably laterally spaced from the drinking aperture. This arrangement provides for a large area of contact between the filter shield and the liquid to increase flow rate through the filter shield. In one arrangement, the filter shield may be attached to the inner side of the lid along its entire perimeter. In another arrangement, the filter shield may have edge portions which are not attached to the inner side of the lid and which may be downwardly spaced from the inner side of the lid. These edge portions may abut or impinge on inner walls of the beverage container when the lid is placed on the open top of the beverage container.

The filter shield may be of a shape (in plane) repeating the shape of the lid, albeit scaled down so that the filter shield can be accommodated on the inner side of the lid and attached thereto. Alternatively, the filter shield may have a shape of a trough. Other suitable shapes are contemplated and are within the scope of the present invention.

The material of the filter shield may be sufficiently rigid to retain its shape during the use of the lid, particularly, when the filter shield is subjected to forces of liquid moving inside the beverage container. If pushed downwardly into the container the first flap may assist in maintaining the rigidity, shape and position of the filter shield when it is subjected to the force of the liquid moving against it when the container is in the tilted position for drinking or pouring.

One function of the filter material of the filter shield is to reduce energy/momentum of the liquid inside the beverage container so as to minimise splashes. This is advantageously achieved due to the provision of the portion of the filter shield downwardly spaced from the drinking aperture so that the liquid loses much of its energy/momentum by the time it reaches the drinking aperture, thereby reducing the possibility of spills or splashes. Another function of the material of the filter shield is for use with liquids containing particles, such as leaf tea or ground coffee. The filter material is preferably sufficiently fine to prevent such particles from passing through the filter shield.

The lid may be provided with a retaining arrangement to help keep the first flap in the open and/or closed position. In one variation, the retaining arrangement may comprise one or more retaining members on the first flap and/or on the lid or the flow deflector arrangement. The one or more retaining members on the first flap may be configured to engage the lid or the flow deflector arrangement or corresponding retaining members on the lid or on the flow deflector arrangement. The one or more retaining members in the first flap may comprise one or more protrusions, preferably resiliently deformable protrusions, which frictionally engage the flow deflecting arrangement or corresponding retaining members on the flow deflector arrangement when the first flap is in the open position. The one or more protrusions disengage from the flow deflecting arrangement or the corresponding retaining members when the first flap is moved into the closed position. The one or more protrusions may be integral with the first flap. The one or more protrusions may be formed by cutting the shape of the protrusion in the lid material, preferably, on the side of the hinge opposite of the first flap, so that the protrusion forms part of the first flap. The one or more protrusions may be adapted to help keep the first flap in the closed position by engaging the lid in the closed position of the first flap. Separate keeping portions may be provided in the first flap, for example, by cutting out the shape of the keeping portion in the lid so the keeping portion forms part of the first flap, for engaging the corresponding portion in the lid to help keep the first flap in the closed position. The lid and the first flap may be provided with a cooperating tab and slot pair to help keep the first flap in the closed position.

In a variation, the flow deflector arrangement defines a window. The window is particularly useful for adding ingredients into the beverage, such as, for example, sugar or another sweetener; stirring the contents of the beverage container or for inserting a straw. The window is preferably located sufficiently spaced apart from the flow opening (e.g. centrally in relation to the lid) such that when the beverage container is tilted for drinking, liquid reaches the drinking aperture through the flow opening and does not flow through the window. Preferably, the first flap normally covers the window when the first flap is in the closed position to prevent splashes. The window can be accessed by moving the first flap into the open position. The window is particularly suitable for the arrangements comprising the permanent shield or the filter shield as described above. The window is also useful in the arrangement where the first flap has a cut out or an aperture as described above.

Optionally, the lid may comprise a spacer element to keep the first flap at a distance from the flow deflector arrangement when the first flap is in the closed position and to keep the first flap from being pushed below the drinking aperture. The spacer element is particularly suitable for the arrangements comprising the permanent shield or the filter shield as described above. The spacer element can be of any suitable form and shape apparent to a person skilled in the art. For example, the spacer element can be a stand up portion of the flow deflector arrangement or a portion on the underside of the first flap. In the variation comprising a window, the spacer element may be formed by a portion of the flow deflector arrangement material, which was in place prior to forming the window.

In a further variation, the permanent shield described above may comprise a shield panel of suitable shape and size provided at the inner side of the lid. The shield panel is preferably spaced from the inner side of the lid. The shield panel may have one or more cut-outs in the proximity of the drinking aperture so as to define the flow opening together with the inner side of the lid. During drinking, when the beverage container is tilted, liquid flows between the wall of the beverage container and the shield panel into the flow opening and towards the drinking aperture. When the beverage container is in the upright position, the shield panel prevents splashes from reaching the drinking aperture. The shield panel may be sized and shaped to fit snugly against the wall of the beverage container. This imparts extra rigidity onto the lid/beverage container assembly and makes the beverage container safer to handle. For example, the shield panel may be shaped to match closely the shape in plane of the wall of the beverage container at a level where the shield panel is located inside the beverage container when the lid is placed on the beverage container. The shield panel may also be of a different shape to the rim of the container, for example the shield panel may be oval shaped where the container rim is circular. In such instances, when the lid closes the beverage container, the shield panel causes the wall of the beverage container to deform (in the case where the material of the beverage container is capable of being deformed by the shield panel) and to assume the shape of the shield panel thereby increasing the rigidity of the lid/beverage container assembly. Simultaneously with imparting rigidity onto the lid/beverage container assembly, the snug fit of the shield panel sealingly secures the lid to the beverage container so that the lid is held securely on the beverage container whilst also preventing leaks.

The shield panel may be attached to the inner side of the lid via connector elements. The connector elements also act as spacers to keep the shield panel spaced from the inner side of the lid. The connector elements may comprise one or more ribs.

In one modification, the connector elements comprise one or more ribs either attached or built into and forming part of each of the lid and the shield panel. On assembly, the ribs of the lid and the shield panel inter-engage so as to couple the lid and the shield panel. In one variation, the lid and the shield panel may each be formed from a piece of planar sheet material, e.g. card paper, and folded along pre-defined lines to form the ribs. In an alternative variation, the connector elements may be formed separately from the lid and shield panels and fixed to them by welding, gluing or other suitable method. Suitable cooperating slots can be made in the ribs so that the ribs attached or part of the lid and those attached or part of the shield panel can engage by crossing each other via the slots upon assembly.

In another modification, the connector elements are movable between expanded and collapsed states. In the expanded state, the connectors may project (e.g. perpendicular or near perpendicular) from the planes of the lid and shield panels and keep the lid and the shield panel in a fixed position spaced from each other, so that in addition to providing a liquid deflection and sealing function the lid, shield and connector elements can work in combination or individually to securely close the beverage container. In the collapsed state the connector elements fold or collapse towards the lid and the shield panels (e.g. parallel or near parallel to the lid and the shield panels) allowing the lid and the shield panels to move closer together so as to reduce or eliminate the space between the lid and the shield panel. Such an arrangement allows a plurality of lids to be stacked and stored whilst minimising storage space required to store the lids. The connector elements may comprise a first rib permanently attached to each of the lid and the shield panel and a second rib. The second rib is preferably permanently attached to one of the lid and the shield panel and removably attached to the other of the lid and the shield panel. The second rib may be removably attached to the lid and the shield panel by a suitable fastening arrangement. The fastening arrangement prevents the first and second ribs from collapsing. The fastening arrangement may comprise, for example, a tab provided on the second rib and a slot formed in the lid or the shield panel, whichever the second rib is removably attached to. In the expanded state of the first and second ribs, the tab is engaged in the slot and the second rib is prevented from articulating relative to the lid or the shield panel, whichever the second rib is attached to. Suitable cooperating cut outs can be made in the first and second ribs so that the first and second ribs can cross each other upon assembly and to permit movement of the first and second ribs relative to each other and articulation relative to the lid and shield panel during movement between the expanded and collapsed states. In one arrangement, the first rib has a pair of first fold lines, one close to the lid, the other close to the shield panel and the second rib has a second fold line close to the lid or the shield panel, whichever the second rib is attached to. When the first and second ribs are moved from the expanded state into the collapsed state, for example, by the user applying external pressure on the lid and the shield panel so as to push the lid and the shield panel towards each other, the fastening arrangement de-couples (or, in a specific arrangement, the tab of the second rib disengages from the slot) and the second rib is disengaged from the lid or the shield panel, whichever the second rib is fastened to via the fastening arrangement. At the same time, the first rib is allowed to articulate about the first fold lines relative to the lid and the shield panel and the second rib is allowed to articulate about the second fold line relative to the lid or the shield panel, whichever the second rib is attached to. As both the first rib and the second rib articulate about their respective first and second fold lines, the lid and the shield panel move close together and the space between the lid and the shield panel is reduced or eliminated. In order to return the first and second ribs into the expanded state, the user applies a force to the lid and the shield panel directed to spreading the lid and the shield panel apart and the above described steps are repeated in reverse order. At the end of the return of the second rib into the expanded state, the fastening arrangement engages (or, in a specific arrangement, the tab of the second rib engages the slot) and the second rib engages the lid or the shield panel, whichever the second rib is fastened to via the fastening arrangement, so as to secure the second rib and the entire assembly in the expanded state. In an alternative variation, the fastening arrangement may comprise an inter-locking mechanism between the first rib and the second rib rather than between one rib and either of the lid or the shield panel.

The connector elements (or ribs) also provide structural support and rigidity to the lid/shield panel assembly as well as impart rigidity on the lid/beverage container assembly. The connector elements may be arranged so as to fit snugly against and/or deform the wall of the beverage container (in the case where the material of the beverage container is capable of being deformed by the connector elements) thereby further increasing the rigidity of the lid/beverage container assembly. Due to the ability of the shield panel and/or the connector elements to fasten the lid to the beverage container, the lid surface and drinking aperture can be substantially level with the rim of the beverage container when the lid closes the beverage container, rather than recessed below or raised above the rim of the beverage container as in other arrangements. In such an arrangement, less tilting of the beverage container is required during drinking. Furthermore, such a lid is considerably easier to manufacture than a lid which is made with a rim having upstanding or depending skirts to fit over or into the top opening of the beverage container. Furthermore, such a lid facilitates the easier stacking of containers upon each other for display, delivery or other purposes.

The lid or the connector elements or shield panel may be of a different shape to the rim of the container, for example the lid may be generally circular or oval where the container rim is circular in order to create friction/pressure and thereby make the contact between the container and the lid and its support structure stronger, although the invention is not limited to this specific shape.

Preferably, the container is a cup.

The flow deflector arrangement of the present invention is provided to minimise spills or prevent splashes during transportation of the container in a generally upright position, e.g. in a user's hand or in a suitable holder. In instances when the container is tilted by the user in order to consume a beverage, the flow deflector arrangement no longer prevents the liquid from flowing through the drinking aperture. However, since the liquid still has to change the direction of flow in order to reach the drinking aperture, the liquid loses more energy/momentum than when flowing directly through the drinking aperture as in prior art lids. The resulting smoother flow renders the process of consumption of a beverage more enjoyable. Since the plane of the flow opening defined by the flow deflector arrangement and the inner side of the lid is substantially perpendicular to the surface of the contents when the container is upright, there is no straight passage for liquid to exit the container. The structure of the lid of the invention allows sudden liquid splashes to be neutralised whilst still providing smooth flow during drinking.

It will be appreciated that features of the various embodiments described above may be combined, where appropriate, with the other embodiments and/or aspects of the invention to form novel and inventive aspects in their own right.

### DETAILED DESCRIPTION OF THE INVENTION

Embodiments of the present invention will now be described, by way of example only, with reference to the accompanying drawings in which:

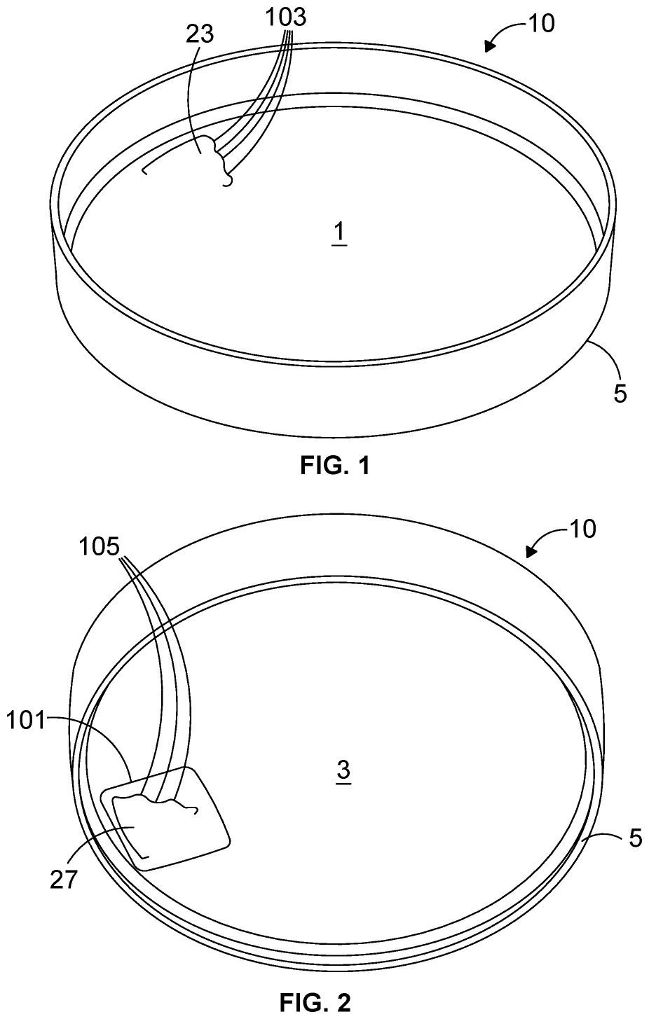

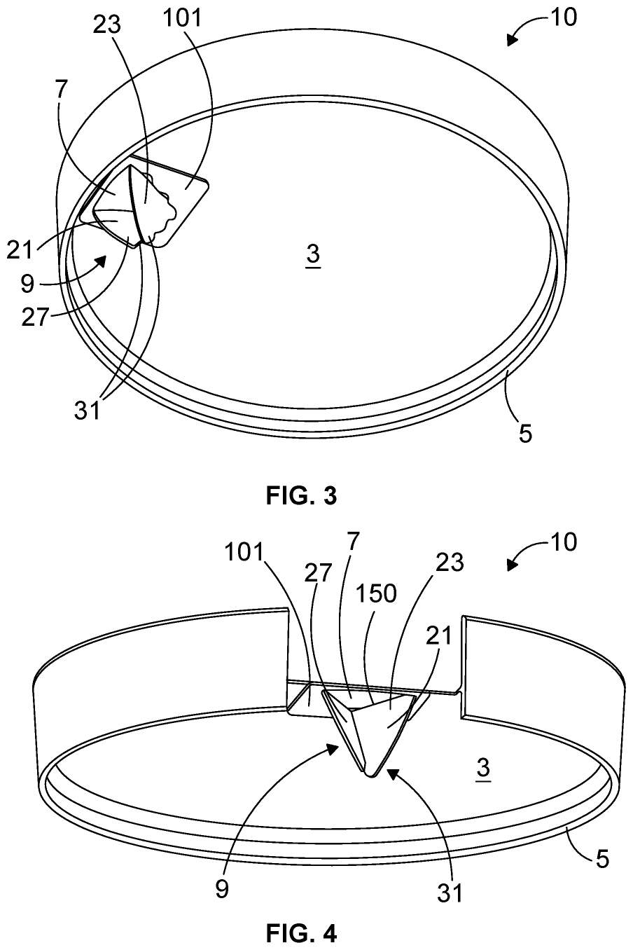

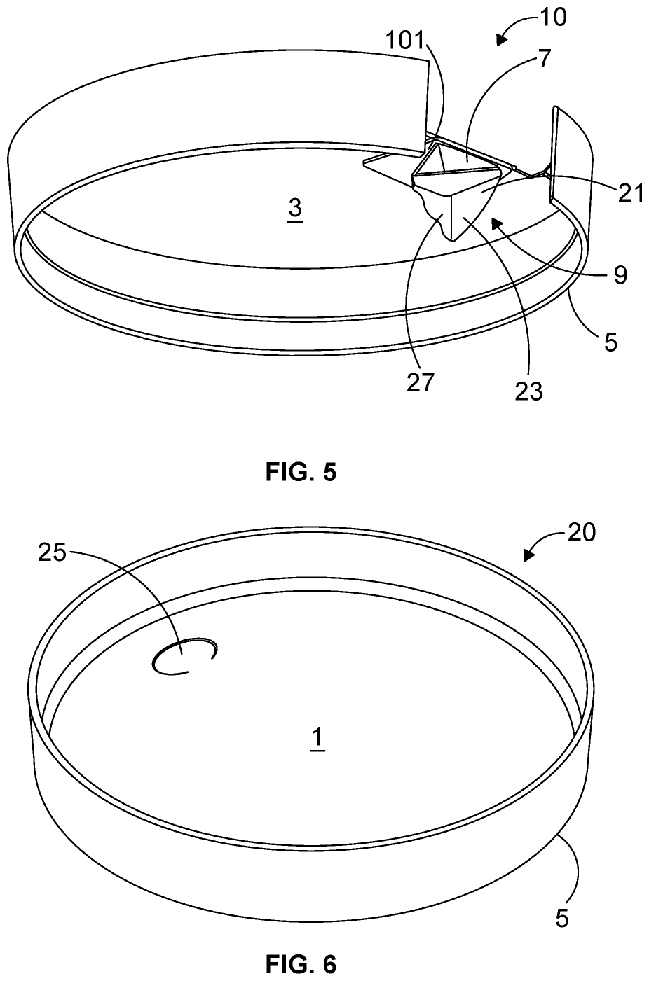

FIGS. 1 to 5 are schematic perspective views of a lid in accordance with the invention;

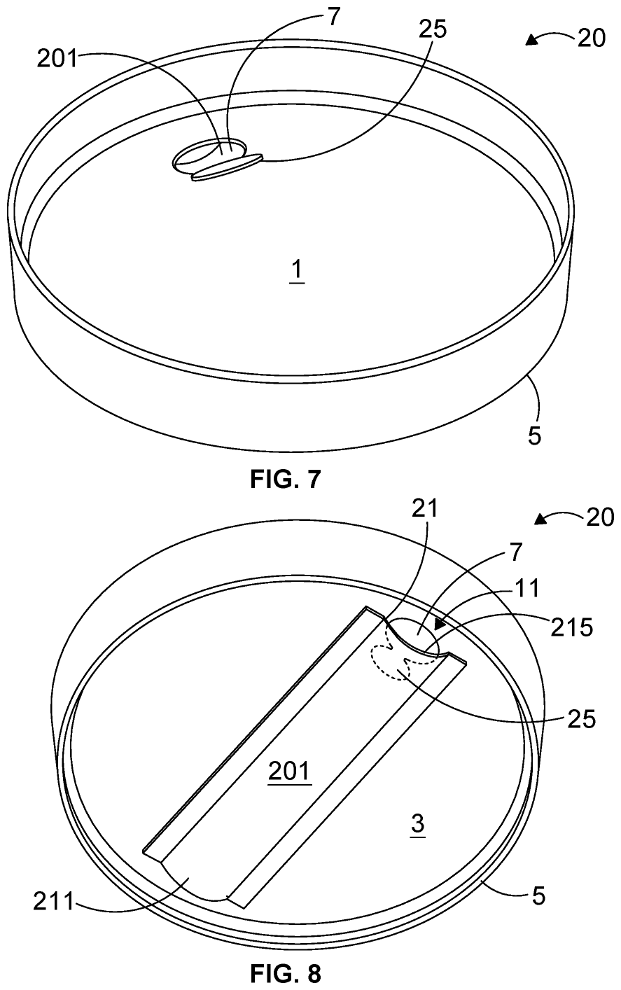

FIGS. 6 to 8 are schematic perspective views of a variation of a lid in accordance with the invention;

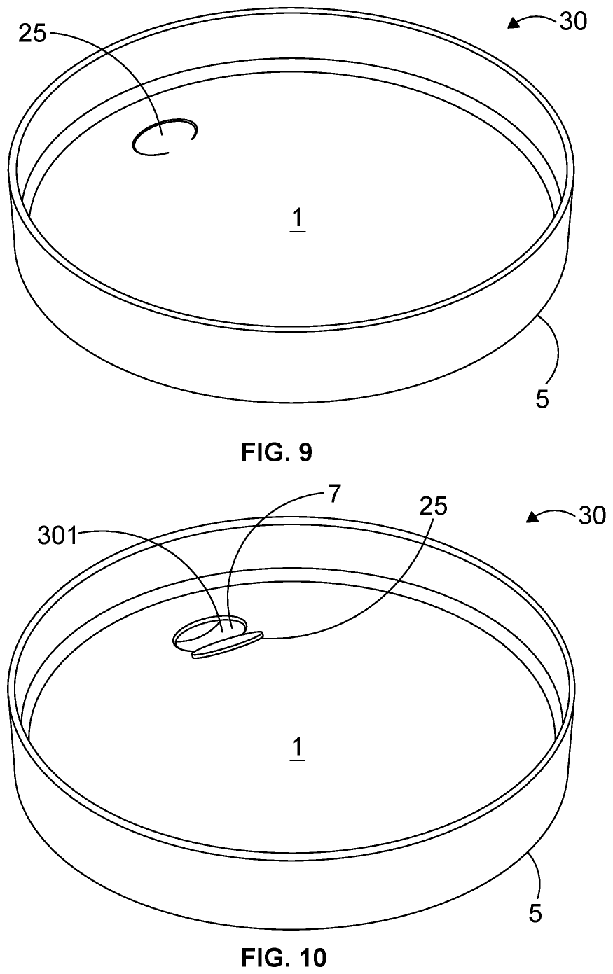

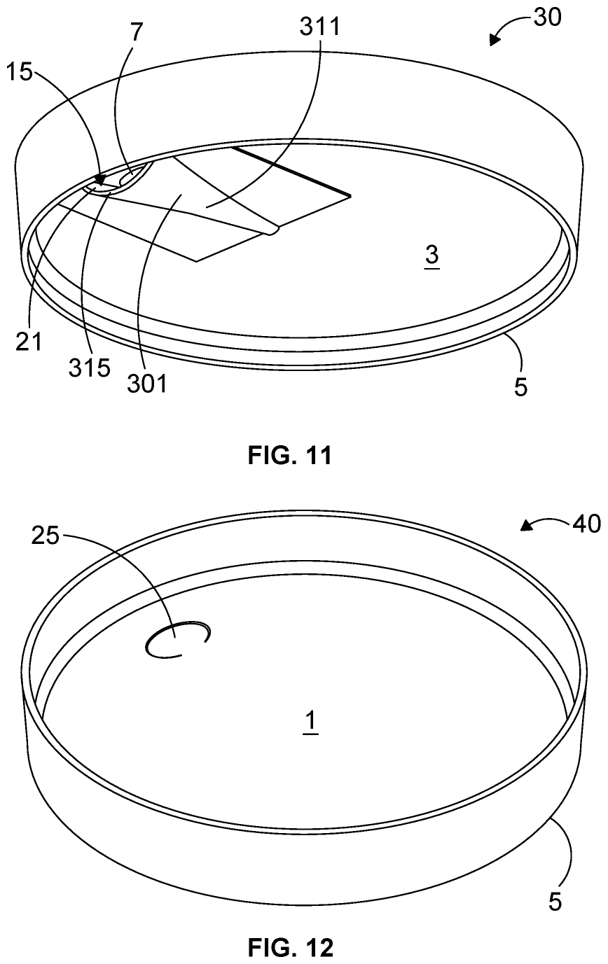

FIGS. 9 to 11 are schematic perspective views of another variation of a lid in accordance with the invention;

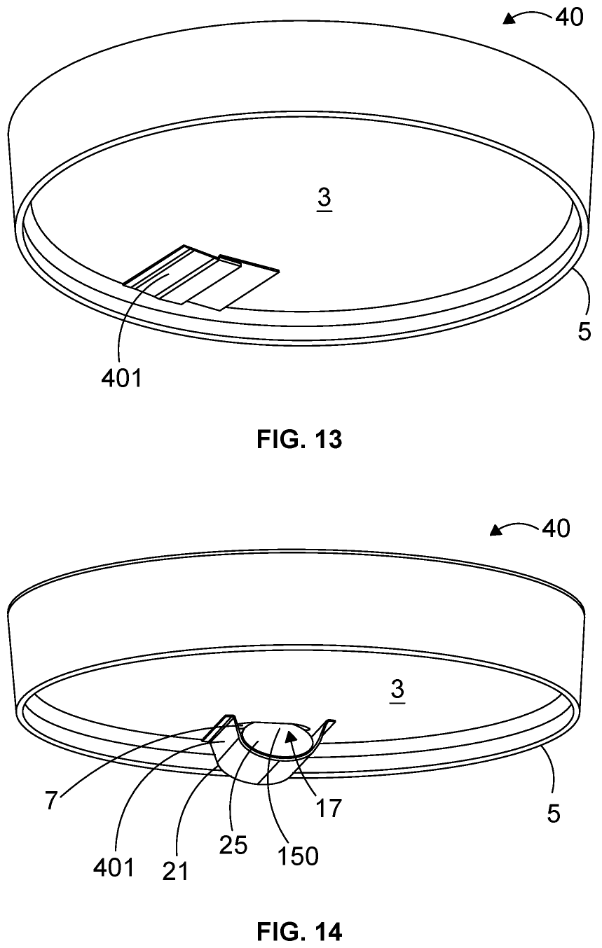

FIGS. 12 to 14 are schematic perspective views of a further variation of a lid in accordance with the invention; and

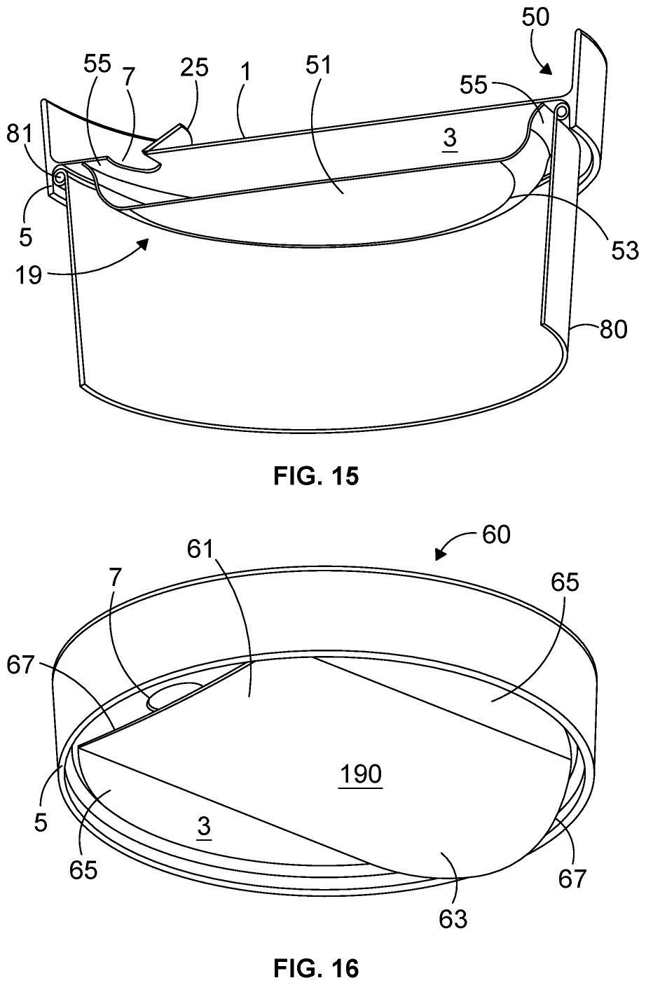

FIGS. 15 and 16 are schematic perspective views of yet a further variation of a lid in accordance with the invention;

FIG. 17 is schematic perspective views of another variation of a lid in accordance with the invention;

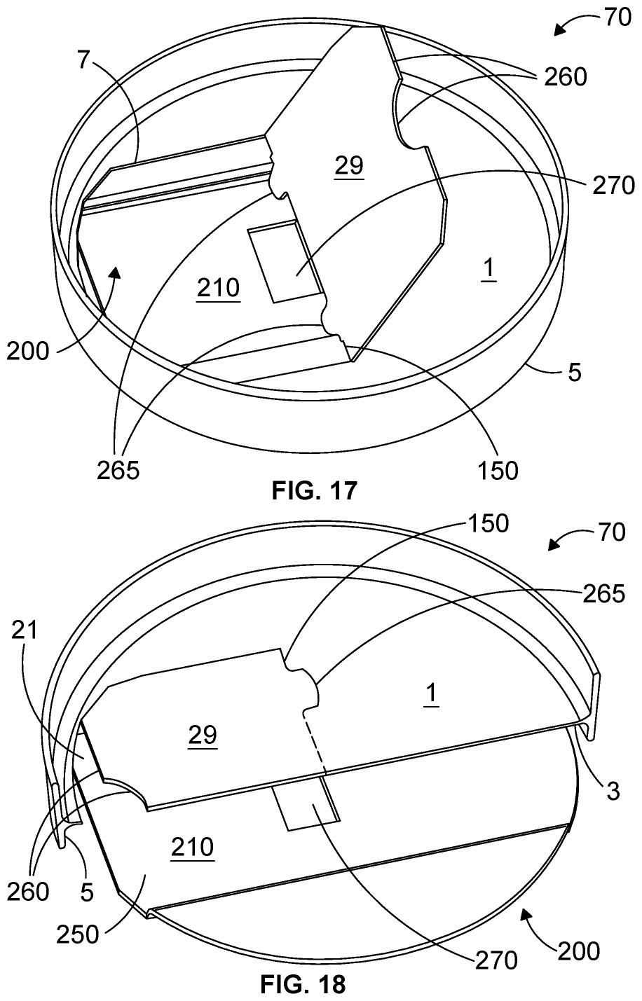

FIGS. 18 and 19 are cutaway views of the lid of FIG. 17;

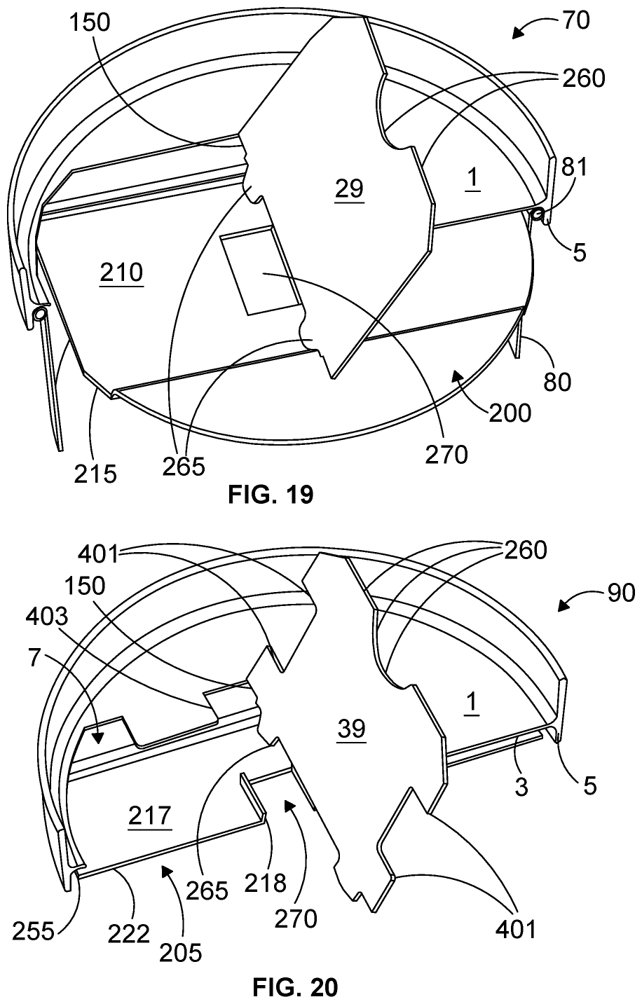

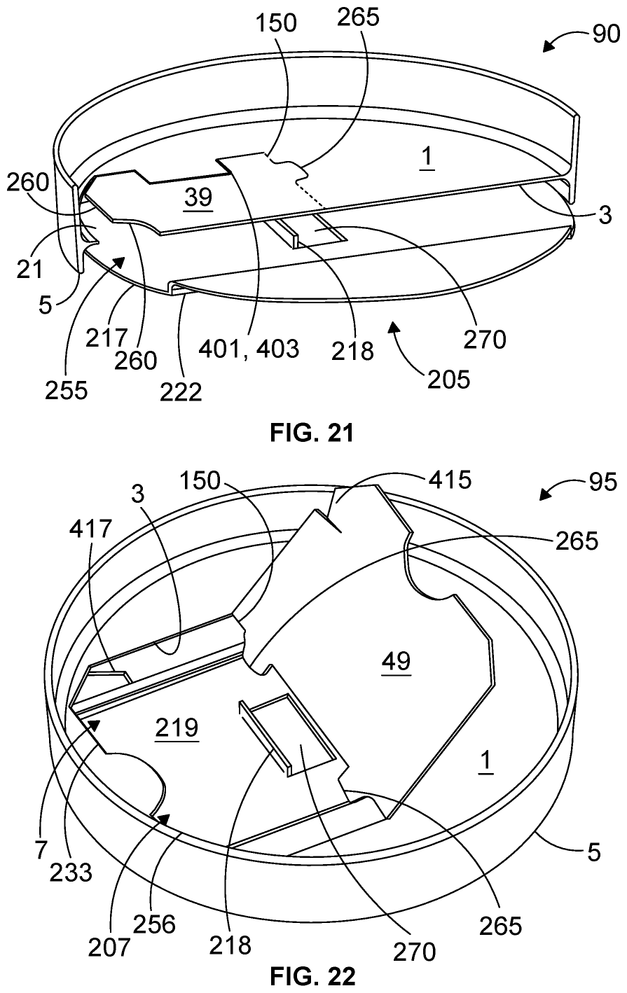

FIGS. 20 and 21 are schematic cutaway perspective views of another variation of a lid in accordance with the invention;

FIG. 22 is schematic perspective view of a further variation of a lid in accordance with the invention;

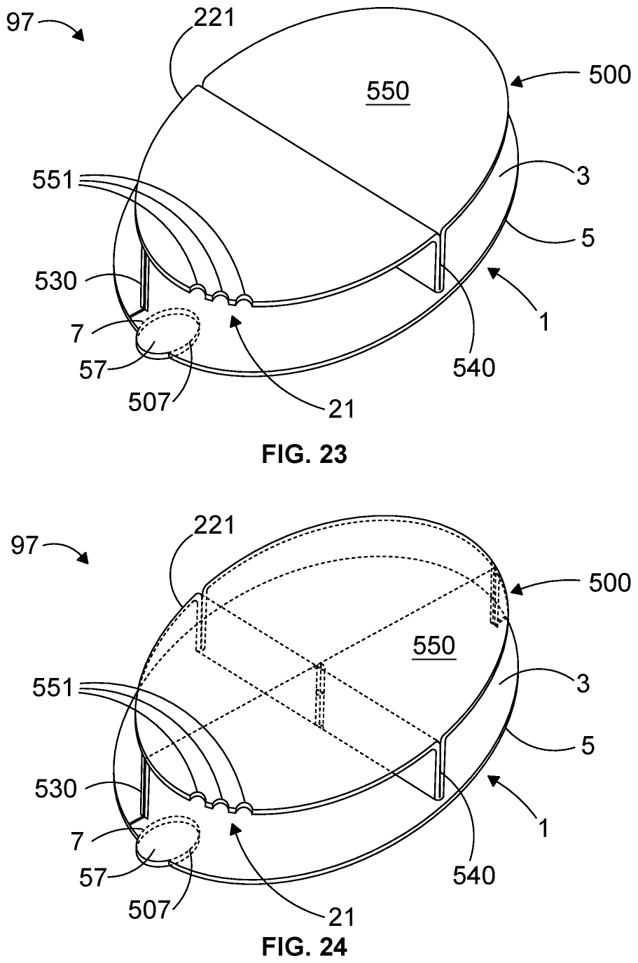

FIG. 23 is schematic perspective view of a further variation of a lid in accordance with the invention;

FIG. 24 is a transparent view of the lid of FIG. 23;

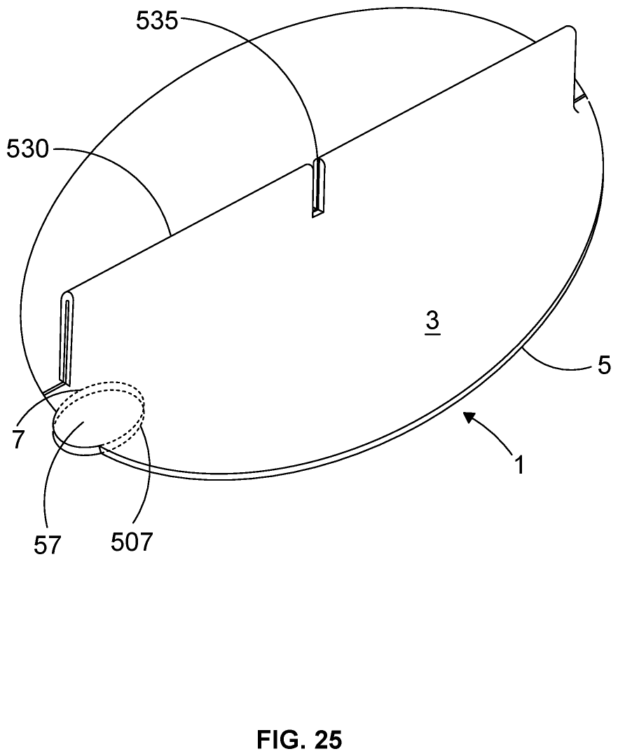

FIG. 25 is a schematic perspective view of a lid part of FIG. 23;

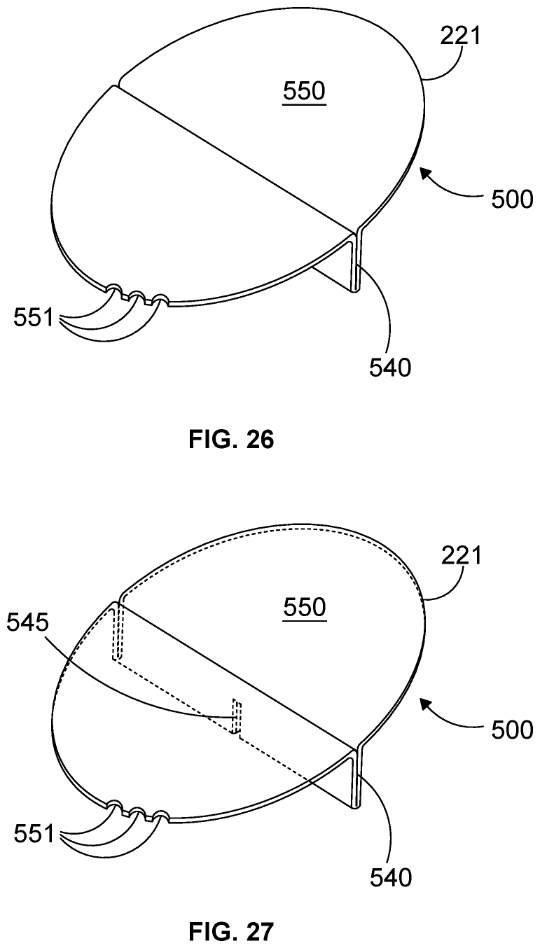

FIG. 26 is a schematic perspective view of a flow deflector part of FIG. 23;

FIG. 27 is a transparent view of the flow deflector of FIG. 26;

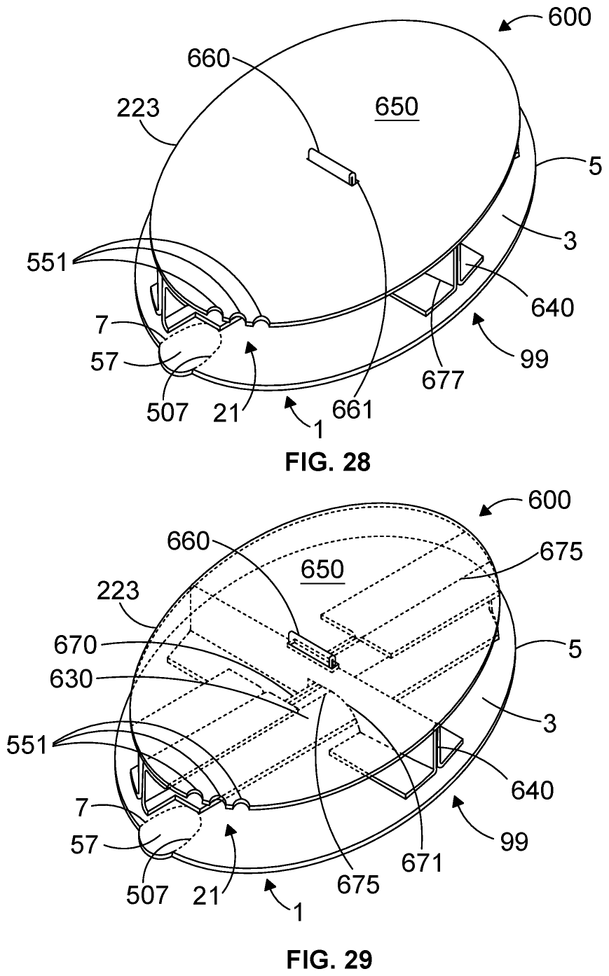

FIG. 28 is schematic perspective view of a modification of a lid of FIGS. 23 to 27;

FIG. 29 is a transparent view of the lid of FIG. 28;

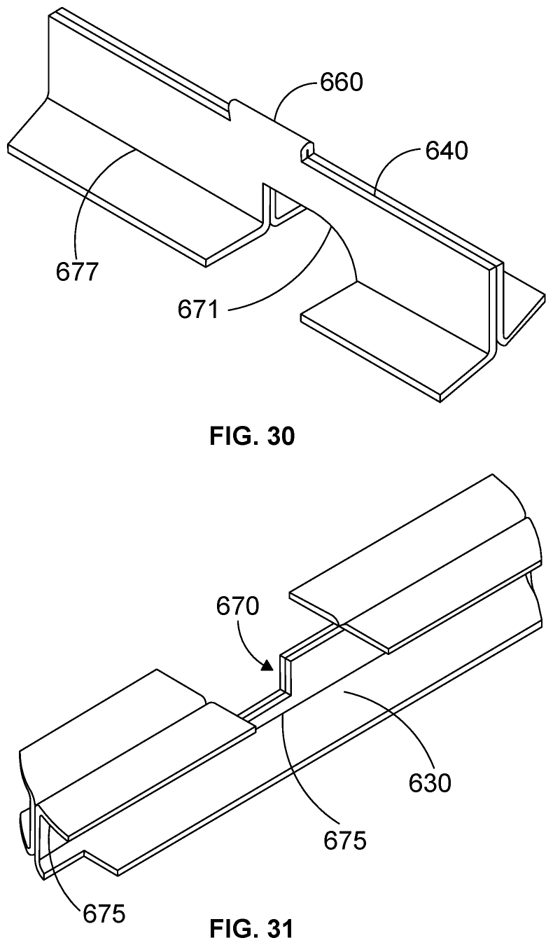

FIGS. 30 and 31 are schematic perspective views of connectors of the lid of FIGS. 28 and 29 in an expanded state;

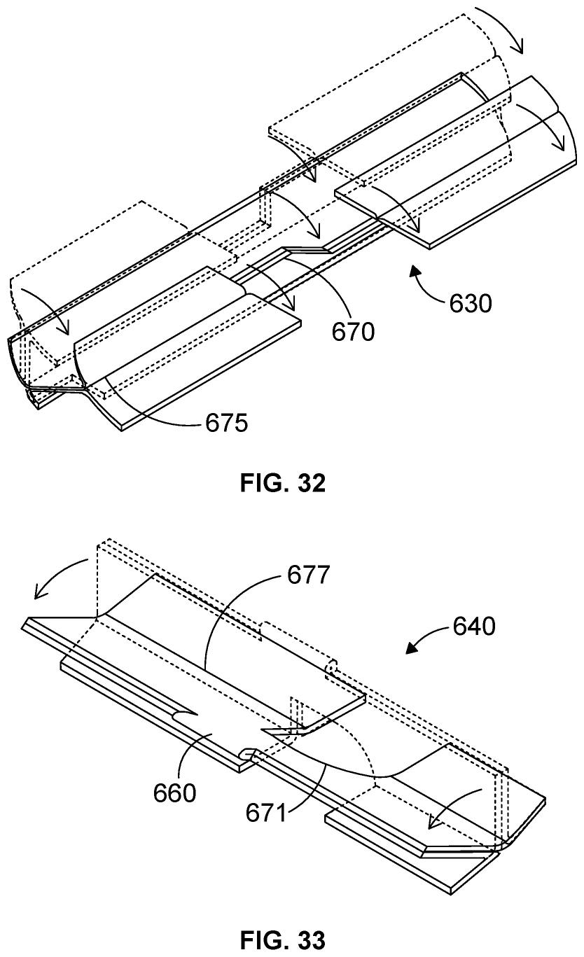

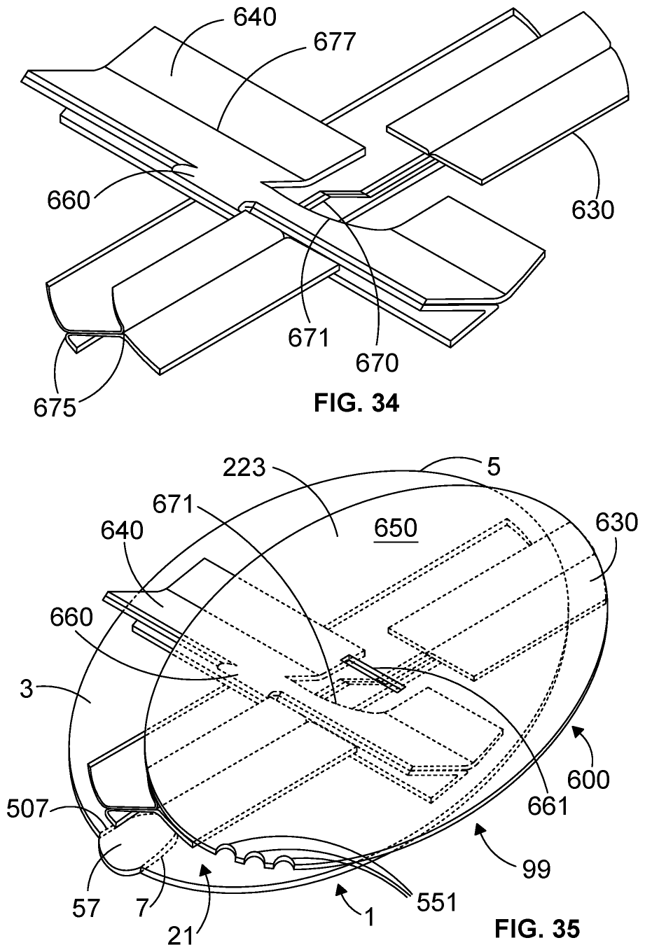

FIGS. 32, 33 and 34 are schematic perspective views of connectors of FIGS. 30 and 31 in a collapsed state;

FIG. 35 is a transparent view of the lid of FIG. 28 in a collapsed state;

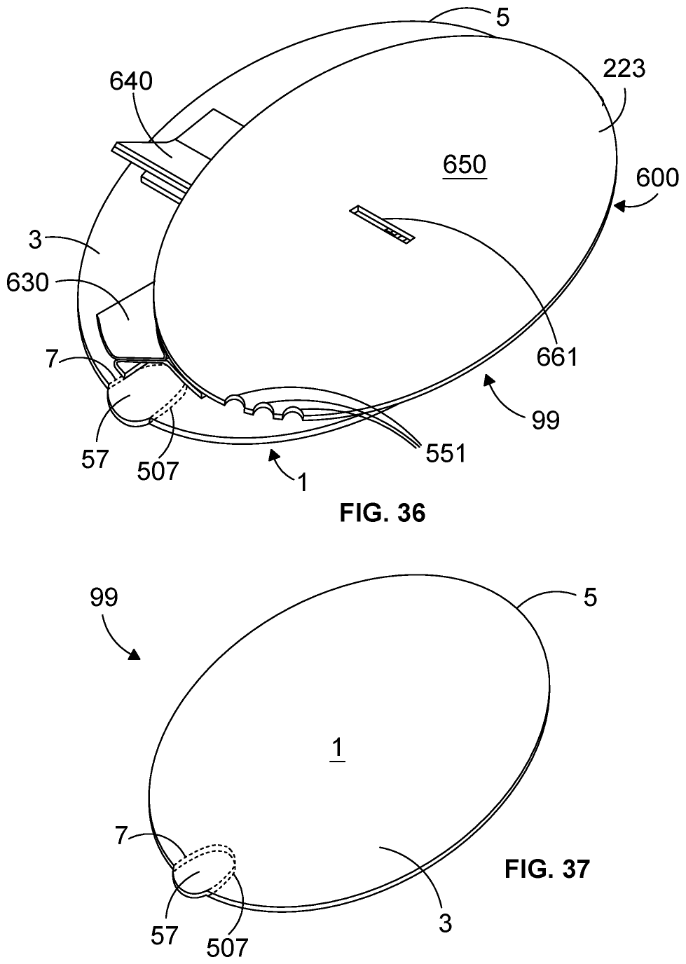

FIG. 36 is a non-transparent view of the lid of FIG. 35; and

FIG. 37 is a schematic perspective view of a lid part of FIG. 36.

In the drawings, a lid in accordance with the invention for a beverage container 80 (shown in FIGS. 15 and 19) is indicated generally using reference numerals 10, 20, 30, 40, 50, 60, 70, 90, 95, 97 and 99. Initially, common features of the lid 10, 20, 30, 40, 50, 60, 70, 90, 95, 97, 99 will be described. Common features have been indicated using the same reference numeral for brevity. The lid 10, 20, 30, 40, 50, 60, 70, 90, 95, 97 99 comprises an outer side 1, an inner side 3 and a rim 5. The lid 10, 20, 30, 40, 50, 60, 70, 90, 95, 97, 99 is adapted to be sealingly fastened to the beverage container 80, about an open top thereof. The lid 10, 20, 30, 40, 50, 60, 70, 90, 95, 97, 99 is adapted to be sealingly fastened to a rim 81 (see FIGS. 15 and 19) of the beverage container 80. The lid 97, 99 is adapted to be sealingly fastened to the internal wall of the beverage container 80, as will be described below. Nevertheless, any of the lid 10, 20, 30, 40, 50, 60, 70, 90, 95, 97, 99 can be adapted to be fastened to the external or internal wall of the beverage container 80. The lid 10, 20, 30, 40, 50, 60, 70, 90, 95, 97, 99 further comprises a drinking aperture 7. In examples, the drinking aperture lies in a plane that is common with the surrounding lid surface, i.e. the drinking aperture is flat to the lid, rather than raised above the lid.

The lid is 10, 20, 30, 40, 50, 60, 70, 90, 95, 97, 99 is preferably made from sheet material. Optionally, the sheet material is foldable sheet material. Optionally, the material is a recyclable, biodegradable or compostable material, such as paper pulp, paperboard, cardboard, vegetable starch or other suitable plant-based material. In examples, the lid may be made from polyethylene terephthalate (PET).

A respective flow deflector arrangement 9, 11, 15, 17, 19, 190, 200, 205, 207, 500 and 600 is provided at the inner side 3 of the lid 10, 20, 30, 40, 50, 60, 70, 90, 95, 97, 99 adjacent the drinking aperture 7.

Optionally, the flow deflector arrangement is separate from the drinking aperture, i.e. the flow deflector does not form part of the drinking aperture 7, and vice versa.

The respective flow deflector 9, 11, 15, 17 in FIGS. 1 to 14, 200 in FIGS. 17 to 19, 205 in FIGS. 20 and 21, 207 in FIG. 22, 500 in FIGS. 23 to 27 and 600 in FIGS. 28 to 37 is configured to prevent liquid contained in the beverage container 80, especially splashing liquid, from flowing directly upwardly through the drinking aperture 7 when the beverage container 80 is in a generally upright orientation. The flow deflector 9, 11, 15, 17, 200, 205, 207, 500, 600 is further configured to allow the liquid to approach the drinking aperture 7 sideways so that the liquid loses much of its energy/momentum by the time it reaches the drinking aperture 7, thereby reducing the possibility of spills or splashes. As will be described below in more detail, the flow deflector 9, 11, 15, 17, 200, 205, 207, 500, 600 comprises a portion arranged in front of the drinking aperture 7 to deflect splashing liquid or to prevent it from flowing directly into the drinking aperture 7. The flow deflector 9, 11, 15, 17, 200, 205, 207, 500, 600 is arranged on the inner side 3 of the lid 10, 20, 30, 40, 70, 90, 95, 97, 99 so as, together with the inner side 3 of the lid 10, 20, 30, 40, 70, 90, 95, 97, 99 to define a flow opening 21 facing sideways relative to the inner side 3 of the lid 10, 20, 30, 40, 70, 90, 95, 97, 99, i.e. towards the inner wall of the beverage container 80 when the lid 10, 20, 30, 40, 70, 90, 95, 97, 99 is in use. The plane of the flow opening 21 may be substantially perpendicular to or oriented at an angle relative to the inner side 3 of the lid 10, 20, 30, 40, 70, 90, 95, 97, 99. Thus, in use, when the beverage container 80 is in a generally upright orientation, the flow deflector 9, 11, 15, 17, 200, 205, 207, 500, 600 prevents splashes from flowing directly into the drinking aperture 7. When the user tilts the beverage container 80 in order to sip the liquid, the liquid first encounters the flow deflector 9, 11, 15, 17, 200, 205, 207, 500, 600 and then approaches the drinking aperture 7 through the flow opening 21. In this manner, the liquid loses much of its energy/momentum by first encountering the flow deflector 9, 11, 15, 17, 200, 205, 207, 500, 600 thereby providing for smoother flow through the drinking aperture 7 during sipping.

The lid 10, 20, 30, 40, 50 comprises a first flap 23, 25 formed in the lid 10, 20, 30, 40, 50 and initially blocking the drinking aperture 7. The first flap 23, 25 is movable between open and closed positions about a hinge 150 (see FIGS. 4, 14 and 17 to 22). The first flap 23, 25 is formed by cutting a shape of the first flap 23, 25 in the lid 10, 20, 30, 40, 50 whilst leaving a portion of the flap shape attached to the lid 10, 20, 30, 40, 50 so that the uncut material forms a hinge about which the first flap 23, 25 can move between open and closed positions.

In the closed position the first flap 23, 25 is positioned across the drinking aperture 7 and in the open position the flap 23, 25 is positioned perpendicular to or at an angle in relation of the plane of the drinking aperture 7. One open position of the first flap 23, 25 may be achieved by pushing the first flap 23, 25 downwardly in the direction from the outer side 1 of the lid 10, 20, 30, 40, 50 towards the inner side 3 of the lid 10, 20, 30, 40, 50. Another open position of the first flap 23, 25 may be achieved by pulling the first flap 23, 25 upwardly in the direction from the inner side 3 of the lid 10, 20, 30, 40, 50 towards the outer side 1 of the lid 10, 20, 30, 40, 50. A suitable gripping arrangement (not shown), e.g. a pulling tab made from a suitable material, e.g. paper or starch, may be provided on the first flap 23, 25 for pulling the first flap 23, 25 upwardly. Although not visible in FIG. 16, the lid 60 also comprises the flap 25 similar to that shown in FIG. 15. The lid 70, 90, 95 comprises a flap 29, 39, 49 which is similar to the flaps 23, 25, but has additional features, which will be described below with reference to FIGS. 17 to 22. The lid 97, 99 comprises a flap 57, which initially is formed with the lid 97, 99 and blocks the drinking aperture 7. The lid 97, 99 comprises a weakened area 507, provided by, for example, perforations or thinning of the lid material. The weakened area 507 defines the flap 57 and allows the flap 57 to be torn off in order to unblock the drinking aperture 7 and to allow drinking from the container 80. Until opened, the lid 97, 99, together with the flap 57, provide a fully sealed closure.

In FIGS. 1 to 5, the flow deflector 9 comprises a panel 101 provided on the inner side 3 of the lid 10 underneath the first flap 23 (or, alternatively, although not shown in the drawings, on the outer side 3 of the lid 10 over the first flap 23). The panel 101 has a second flap 27 formed in the panel 101 and the second flap 27 being movable between open and closed positions. In the closed position the second flap 27 is oriented across the drinking aperture 7 and in the open position the second flap 27 is positioned perpendicular to or at an angle in relation of the plane of the drinking aperture 7. The first and second flaps 23, 27 are superimposed so that when the upper one of the first and second flaps 23, 27 is pushed through the drinking aperture 7, the lower one of the first and second flaps 23, 27 is also pushed by the upper flap into the open position. When both the first and the second flaps 23, 27 have been pushed downwardly into the open position, the first and second flaps 23, 27 remain engaged and thereby, on the one hand, form a shield 31 adjacent to the drinking aperture 7 and, on the other hand, together with the inner side 3 of the lid 10, define the flow opening 21. Each of the first and second flaps 23, 27 may have cooperating engaging elements 103, 105, such as, for example, teeth or suitably formed cooperating protrusions, configured to engage when the first and second flaps 23, 27 have been pushed into the open position and to prevent the first and second flaps 23, 27 from moving back into the closed position. During drinking, when the beverage container 80 is tilted, liquid flows between the wall of the beverage container 80 and the shield 31 formed by the first and second flaps 23, 27 into the flow opening 21 and towards the drinking aperture 7. When the beverage container 80 is in the upright position, the shield 31 prevents splashes from reaching the drinking aperture 7.

In FIGS. 6 to 11 and 17 to 37, the respective flow deflector 11, 15, 200, 205, 207, 500 comprises a respective permanent shield 201, 301, 210, 217, 219, 221, 223 of suitable shape and size formed on the inner side 3 of the lid 20, 30, 70, 90, 95, 97.

The permanent shield 201, 301, 210, 217, 219 of FIGS. 6 to 11 and 17 to 22 is provided as an elongated trough 211, 311, 215, 222, 233 attached to the inner side 3 of the lid 20, 30, 70, 90, 95. The trough 211, 311, 215, 222, 233 may have at least one open end 215, 315, 250, 255, 256 adjacent the drinking aperture 7 and in use facing the wall of the beverage container 80 so as to define the flow opening 21 together with the inner side 3 of the lid 11, 15, 70, 90, 95. In FIGS. 6 to 8 and 17 to 22, the trough 211, 215, 222, 233 has a uniform width. Alternatively, as shown in FIGS. 9 to 11 the trough 311 has walls converging in the direction away from the open end 315 and towards the inner side 3 of the lid 15. The first flap 25 can be either opened outwardly or downwardly. Upon being pushed downwardly through the drinking aperture 7, the first flap 25 may form part of the shield 201, 301. During drinking, when the beverage container 80 is tilted, liquid flows between the wall of the beverage container 80 and the permanent shield 201, 301, 210, 217, 219 into the flow opening 21 and towards the drinking aperture 7. When the beverage container 80 is in the upright position, the permanent shield 201, 301, 210, 217, 219 prevents splashes from reaching the drinking aperture 7 or at least mitigates such an occurrence. In FIGS. 23 to 37, the permanent shield 221, 223 comprises a shield panel 550, 650 of suitable shape and size provided at the inner side 3 of the lid 97, 99, spaced from the inner side 3 of the lid 97, 99 as will be described in more detail below.

In FIGS. 12 to 14, the flow deflector 17 comprises a pop up shield 401 of suitable shape and size formed on the inner side 3 of the lid 40 across the drinking aperture 7. The pop up shield 401 may be folded prior to use. The pop up shield 401 may be unfolded by pushing the first flap 25 downwardly through the drinking aperture 7 and thereby expanding the pop up shield 401. Upon being pushed downwardly through the drinking aperture 7, the first flap 25 may form part of the shield 401. During drinking, when the beverage container 80 is tilted, liquid flows between the wall of the beverage container 80 and the pop up shield 401 into the flow opening 21 and towards the drinking aperture 7. When the beverage container 80 is in the upright position, the pop up shield 401 prevents splashes from reaching the drinking aperture 7.

In FIGS. 15 and 16, the flow deflector 19, 190 comprises a filter shield 51, 61 made from a liquid pervious material and arranged on the inner side 3 of the lid 50, 60 across the drinking aperture 7. The liquid pervious material has pores sufficiently fine to reduce or minimise splashes, but capable of allowing liquid to flow through the drinking aperture 7 during drinking. The liquid pervious material may be any type of suitable material which is capable of allowing liquid to pass through but preventing solid particles which may be dispersed in the liquid from passing through it. For example only and without any limitation, the liquid pervious material may comprise a woven, knit, or knotted material of open texture, such a piece of mesh or fabric, a non-woven material, such as filter paper or non-woven fabric, e.g. made from cellulose or chemical fibres, or a porous article, such as, for example, pierced film, non-woven, e.g. extruded mesh. The filter shield 51, 61 has a portion 53, 63 downwardly spaced from the drinking aperture 7 (i.e. away from the inner side 3 of the lid 51, 61) and peripheral portions 55, 65 by which the filter shield 51, 61 is attached to the inner side 3 of the lid 50, 60 laterally spaced from the drinking aperture 7.

In the embodiments of FIGS. 15 and 16, the peripheral portions 55, 65 are attached to the inner side 3 of the lid 50, 60 adjacent the rim 5 of the lid 50, 60. In the arrangement of FIG. 15, the filter shield 51 is attached to the inner side 3 of the lid 50 along its entire perimeter. In the arrangement of FIG. 16, the filter shield 61 has edge portions 67 which are not attached to the inner side 3 of the lid 60 and which are downwardly spaced from the inner side 3 of the lid 60. These edge portions 67 abut or impinge on inner walls of the beverage container 80 when the lid 60 is placed on the open top of the beverage container 80.

In FIG. 15, the filter shield 51 is of a shape (in plane) repeating the shape of the lid 50, albeit scaled down so that the filter shield 51 can be accommodated on the inner side 3 of the lid 50 and attached thereto. In FIG. 16, the filter shield 61 has a shape of a trough. Other suitable shapes are contemplated and are within the scope of the present invention.

The material of the filter shield 51, 61 is preferably sufficiently rigid to retain its shape during the use of the lid 50, 60, particularly, when the filter shield 51, 61 is subjected to forces of liquid moving inside the beverage container 80.

In the embodiment of FIGS. 17 to 19, the first flap 29 of the lid 70 has a cut out 260 defined in the first flap 29 to allow the first flap to be lifted and also to permit drinking without the need for the first flap 29 to be moved into the open position. In this arrangement, the first flap 29 can still be moved into the open position, if desired, for an enhanced flow. The lid 70 may be provided with a retaining arrangement to help keep the first flap 29 in the open position. In the embodiment of FIGS. 17 to 19, the retaining arrangement comprises a pair of retaining members formed on the first flap 29. The retaining members in the first flap 29 comprise a pair of resiliently deformable protrusions 265, which frictionally engage shield 210 when the first flap 29 is in the open position. The protrusions 265 disengage from the shield 210 when the first flap 29 is moved into the closed position. The protrusions 265 are integrally formed with the first flap 29 by cutting the shape of the protrusions 265 in the lid material on the side of the hinge 150 opposite the first flap 29, so that the protrusions 265 form part of the first flap 29. The protrusions 265 also help keep the first flap 29 in the closed position by engaging the lid 70 in the closed position of the first flap 29.

The shield 210 defines a window 270. The window 270 is particularly useful for adding ingredients into the beverage, such as, for example, sugar or another sweetener; stirring the contents of the beverage container 80 or for inserting a straw. The window 270 is located sufficiently spaced apart from the flow opening 21 such that when the beverage container 80 is tilted for drinking, liquid reaches the drinking aperture 7 through the flow opening 21 and does not flow through the window 270. The first flap 29 normally covers the window 270 when the first flap 29 is in the closed position to prevent splashes. The window 270 can be accessed by moving the first flap 29 into the open position. The window 270 is also suitable for the arrangement comprising the filter shield 51, 61 (FIGS. 15, 16) as described above.

In the embodiments of FIGS. 20 to 22, lids 90 and 95 are generally similar to the lid 70 of FIGS. 17 to 19 and elements common among the embodiments of FIGS. 17 to 22 are indicated using common reference numerals.

In FIGS. 20 and 21, separate keeping portions 401 are provided in the first flap 39 by cutting out the shape of the keeping portions 401 in the lid 90 so the keeping portion 401 forms part of the first flap 39, for engaging the corresponding portion 403 in lid 90 to help keep the first flap 39 in the closed position.

In FIG. 22, the first flap has a tab 415 and the shield 219 has a slot 417. When the first flap 49 is in the closed position, the user can insert the tab 415 into the slot 417 to keep the first flap 49 in the closed position.

The lid 90, 95 of FIGS. 20 to 22 has a spacer element 218 to keep the first flap 39, 49 at a distance from the shield 217, 219 when the first flap 39, 49 is in the closed position and to keep the first flap 39, 49 from being pushed below the drinking aperture 7. The spacer element 218 is also suitable for the arrangements comprising the permanent shield 201, 301, 210 or the filter shield 51, 61 as described above. The spacer element 218 can be of any suitable from and shape apparent to a person skilled in the art. In the embodiments of FIGS. 20 to 22, the spacer element is provided as a stand up portion of the shield 217, 219 formed by a portion of the material of the shield 217, 219, which was in place prior to forming the window 270.

In FIGS. 23 to 37, the shield panel 550, 650 has cut-outs 551 in the proximity of the drinking aperture 7 so as to define the flow opening 21 together with the inner side 3 of the lid 97, 99. During drinking, when the beverage container 80 is tilted, liquid flows between the wall of the beverage container 80 and the shield panel 550, 650 into the flow opening 21 and towards the drinking aperture 7. When the beverage container 80 is in the upright position, the shield panel 550, 650 prevents splashes from reaching the drinking aperture 7. The shield panel 550, 650 is sized and shaped to fit snugly against the internal wall of the beverage container 80. This imparts extra rigidity onto the lid 97,99/beverage container 80 assembly and makes the beverage container 80 safer to handle. In the embodiment of FIGS. 23 to 37, the shield panel 550, 650 and the lid 97,99 are oval shaped. When the lid 97, 99 closes the beverage container 80 and the shield panel 550, 650 is inserted into the top opening of the beverage container 80, the shield panel 550, 650 snugly engages the wall of the beverage container 80 and causes it to deform (in the case where the material of the beverage container 80 is capable of being deformed by the shield panel 550, 650) and to assume the oval shape of the shield panel 550, 650 thereby increasing the rigidity of the lid 97, 99/beverage container 80 assembly. In other variations, the shield panel 550, 650 may be shaped to match closely the shape in plane of the wall of the beverage container 80 at a level where the shield panel 550, 650 is located inside the beverage container 80 when the lid 97, 99 is placed on the beverage container 80. Such a shape is still sufficient to impart rigidity onto the lid 97, 99/beverage container 80 assembly. Simultaneously with imparting rigidity onto the lid 97, 99/beverage container 80 assembly, the snug fit of the shield panel 550, 650 against the wall of the beverage container 80 sealingly secures the lid 97, 99 to the beverage container 80 so that the lid 97, 99 is held securely in place whilst preventing leaks. The shield panel 550, 650 may be attached to the inner side 3 of the lid 97, 99 via connector elements. The connector elements also act as spacers to keep the shield panel 550, 650 spaced from the inner side 3 of the lid 97, 99. The connector elements may comprise one or more ribs.

In the embodiment of FIGS. 23 to 27, the connector elements comprise a rib 530, 540 on each of the lid 97 and the shield panel 550. On assembly, the ribs 530, 540 of the lid 97 and the shield panel 550 inter-engage so as to couple the lid 97 and the shield panel 550. In the embodiment of FIGS. 23 to 27, the lid 97 and the shield panel 550 are each formed from a piece of planar sheet material, e.g. card paper, and folded along pre-defined lines to form the ribs 530, 540. Cooperating slots 535, 545 are provided in the ribs 530, 540 so that the ribs 530, 540 can engage by crossing each other via the slots 535, 545 upon assembly.

In the embodiment of FIGS. 28 to 37, the connector elements are movable between expanded and collapsed states and comprise first and second ribs 630, 640, respectively. In the expanded state, the ribs 630, 640 keep the lid 99 and the shield panel 650 spaced from each other, so that the lid 99 can be used to close the beverage container 80. When the ribs 630, 640 collapse, as detailed below, the lid 99 and the shield panel 650 are moved together so as to reduce or eliminate the space between the lid 99 and the shield panel 650. Such an arrangement allows a plurality of lids 99 to be stacked and stored whilst minimising storage space required to store the lids 99. In the embodiment of FIGS. 28 to 37, the first rib 630 is permanently attached to each of the lid 99 and the shield panel 650. The second rib 640 is permanently attached to the lid 99 and removably attached to the shield panel 650 via a fastening arrangement. In other embodiments, the second rib 640 may be permanently attached to the shield panel 650 and removably attached to the lid 99. The fastening arrangement prevents the first and second ribs 630, 640 from collapsing. In the embodiment of FIGS. 28 to 37, the fastening arrangement comprises a tab 660 provided on the second rib 640 and a slot 661 formed in the shield panel 650. As shown in FIGS. 28 and 29, in the expanded state of the first and second ribs 630, 640, the tab 660 is engaged in the slot 661 and the second rib 640 is prevented from articulating relative to the lid 99. Cooperating cut outs 670, 671 are made in the first and second ribs 630, 640, respectively, so that the first and second ribs 630, 640 can cross each other upon assembly and to permit movement of the first and second ribs 630, 640 relative to each other and articulation relative to the lid 99 and shield panel 650 during movement between the expanded and collapsed states. As shown in FIGS. 29, 31, the first rib 630 has a pair of first fold lines 675, one close to the lid 99, the other close to the shield panel 650. As shown in FIGS. 28, 30, the second rib 640 has a second fold line 677 close to the lid 99. The first and second ribs 630, 640 can be moved from the expanded state into the collapsed state by the user applying external pressure on the lid 99 and the shield panel 650 so as to push the lid 99 and the shield panel 650 towards each other. Referring to FIGS. 32 to 36, when the first and second ribs 630, 640 are moved from the expanded state into the collapsed state, the tab 660 of the second rib 640 disengages from the slot 661 and the second rib 640 disengages from the shield panel 650. At the same time, the first rib 630 is allowed to articulate about the first fold lines 675 relative to the lid 99 and the shield panel 650 and the second rib 640 is allowed to articulate about the second fold line 677 relative to the lid 99. As both the first rib 630 and the second rib 640 articulate about their respective first and second fold lines 675, 677, the lid 99 and the shield panel 650 move close together and the space between the lid 99 and the shield panel 650 is reduced or eliminated. In order to return the first and second ribs 630,640 into the expanded state (as shown in FIGS. 28, 29), the user applies a force to the lid 99 and the shield panel 650 directed to spreading the lid 99 and the shield panel 650 apart and the above described steps are repeated in reverse order. At the end of the return of the second rib 640 into the expanded state, the tab 660 of the second rib 640 engages the slot 661 and the second rib 640 engages the lid 99 so as to secure the second rib 640 and the entire lid 99/shield panel 650 assembly in the expanded state.

The ribs 530, 540, 630, 640 also provide structural support and rigidity to the lid 97, 99/shield panel 550, 650 assembly as well as impart rigidity on the lid 97, 99/beverage container 80 assembly. The ribs 530, 540, 630, 640 are preferably configured to fit snugly against and/or deform the wall of the beverage container 80 (in the case where the material of the beverage container 80 is capable of being deformed by the ribs 530, 540, 630, 640) thereby further increasing the rigidity of the lid 97, 99/beverage container 80 assembly.

Due to the ability of the shield panel 550, 650 to fasten the lid 97, 99 to the beverage container 80, the outer side 1 of the lid and drinking aperture 7 can be substantially level with the rim 81 of the beverage container 80 when the lid 97, 99 closes the beverage container 80, rather than recessed below or raised above the rim 81 of the beverage container 80 as in other arrangements. In such an arrangement, less tilting of the beverage container 80 is required during drinking.

The lid 10, 20, 30, 40, 50, 60, 70, 90, 95, 97, 99 may be generally circular or oval, to make the contact between the container 80 and the lid 10, 20, 30, 40, 50, 60, 70, 90, 95, 97, 99 stronger, in plane although the invention is not limited to this specific shape.

Whilst specific embodiments of the present invention have been described above, it will be appreciated that modifications are possible within the scope of the present invention as defined in the appended claims.

1-68. (canceled)

69. A lid for a beverage container, the lid comprising:
an outer side, an inner side and a rim;
a drinking aperture formed in the lid; and
a flow deflector arrangement adjacent to the drinking aperture, wherein the lid or parts thereof are formed from sheet material.

70. The lid as claimed in claim 69, wherein the lid comprises a first flap formed in the lid and initially blocking the drinking aperture;
optionally wherein the first flap is movable between open and closed positions, wherein in the closed position, the first flap is positioned across the drinking aperture and in the open position the flap is positioned perpendicular to or at an angle in relation of the plane of the drinking aperture; and
optionally, wherein the flow deflector arrangement is independent from the first flap.

71. The lid as claimed in claim 70, wherein the flow deflector arrangement comprises a panel provided on the inner side of the lid underneath the first flap or on the outer side of the lid over the first flap, the panel having a second flap formed in the panel and the second flap being movable between open and closed positions, wherein in the closed position, the second flap is oriented across the drinking aperture and in the open position the second flap is positioned perpendicular to or at an angle in relation of the plane of the drinking aperture;
optionally, wherein the first and second flaps are superimposed so that when the upper one of the first and second flaps is pushed through the drinking aperture, the lower one of the first and second flaps is also pushed by the upper flap into the open position, wherein when both the first and the second flaps have been pushed downwardly into the open position, the first and second flaps remain engaged and, thereby form a shield adjacent to the drinking aperture and, simultaneously, together with the inner side of the lid, define the flow opening.

72. The lid as claimed in claim 69, wherein the flow deflector arrangement comprises a permanent shield of suitable shape and size formed on the inner side of the lid;
optionally, wherein the permanent shield is provided as an elongated trough attached to the inner side of the lid, wherein the trough has at least one open end adjacent the drinking aperture and facing sideways in relation to the inner side of the lid, i.e. towards the wall of the container in use, so as to define the flow opening together with the inner side of the lid.
optionally, wherein the flow deflector arrangement comprises a filter shield made from a liquid pervious material and arranged on the inner side of the lid across the drinking aperture, the liquid pervious material comprising pores sufficiently fine to reduce or minimize splashes, but capable of allowing liquid to flow through the drinking aperture during drinking;
optionally, wherein the liquid pervious material is capable of allowing liquid to pass through but preventing solid particles which may be dispersed in the liquid from passing through it; and
optionally, wherein the filter shield has a portion downwardly spaced from the drinking aperture, i.e. away from the inner side of the lid, and peripheral portions by which the filter shield is attached to the inner side of the lid laterally spaced from the drinking aperture.

73. The lid as claimed in claim 72, wherein the lid comprises a first flap formed in the lid and initially blocking the drinking aperture;
wherein the first flap is movable between open and closed positions, wherein in the closed position, the first flap is positioned across the drinking aperture and in the open position the flap is positioned perpendicular to or at an angle in relation of the plane of the drinking aperture, and
wherein upon being pushed downwardly through the drinking aperture, the first flap forms part of the shield.

74. The lid as claimed in claim 69, wherein the flow deflector arrangement comprises a portion arranged substantially in front of the drinking aperture to deflect splashing liquid or to prevent it from flowing directly into the drinking aperture; wherein the flow deflector arrangement is arranged on the inner side of the lid so as, together with the inner side of the lid, to define a flow opening facing sideways relative to the inner side of the lid, i.e. towards a wall of the beverage container when the lid is in use; and wherein the flow deflector arrangement comprises a pop up shield of suitable shape and size formed on the inner side of the lid across the drinking aperture;
optionally, wherein:
the lid comprises a first flap formed in the lid and initially blocking the drinking aperture; and the first flap is movable between open and closed positions, wherein in the closed position, the first flap is positioned across the drinking aperture and in the open position the flap is positioned perpendicular to or at an angle in relation of the plane of the drinking aperture, wherein the pop up shield is folded prior to use and the pop up shield is unfolded by pushing the first flap downwardly through the drinking aperture thereby expanding the pop up shield, wherein upon being pushed downwardly through the drinking aperture, the first flap forms part of the shield.

75. The lid as claimed in claim 72, wherein the permanent shield comprises a shield panel provided at the inner side of the lid spaced from the inner side of the lid;
optionally, wherein the shield panel has one or more cut-outs in the proximity of the drinking aperture so as to define the flow opening together with the inner side of the lid;
optionally, wherein the shield panel is sized and shaped to fit snugly against the wall of the beverage container in use;
optionally, wherein the shield panel is of a different shape to the rim of the container, such that when the lid closes the beverage container, the shield panel causes the wall of the beverage container to deform and to assume the shape of the shield panel.

76. The lid as claimed in claim 75, wherein the shield panel attached to the inner side of the lid via connector elements, wherein the connector elements are also configured to act as spacers to keep the shield panel spaced from the inner side of the lid;
optionally, wherein the connector elements are arranged so as to fit snugly against and/or deform the wall of the beverage container in use;
optionally, wherein the connector elements are formed separately from the lid and shield panels and fixed to them by welding, gluing or other suitable method.

77. The lid as claimed in claim 76, wherein the connector elements are movable between expanded and collapsed states, wherein in the expanded state, the connectors project from the planes of the lid and shield panels and keep the lid and the shield panel in a fixed position spaced from each other and in the collapsed state the connector elements fold or collapse towards the lid and the shield panels whereby the shield panels are moved closer together thereby reducing or eliminating the space between the lid and the shield panel.

78. The lid as claimed in claim 76, wherein the connector elements comprise one or more ribs on each of the lid and the shield panel, wherein, on assembly, the ribs of the lid and the shield panel are configured to inter-engage so as to couple the lid and the shield panel;
optionally, wherein the lid and the shield panel are each formed from a piece of planar sheet material and folded along pre-defined lines to form the ribs;
optionally, wherein suitable cooperating slots are made in the ribs so that the ribs of the lid and those of the shield panel engage upon assembly by crossing each other via the slots;
optionally, wherein the ribs comprise a first rib attached to each of the lid and the shield panel and a second rib, wherein the second rib is attached to one of the lid and the shield panel and removably attached to the other of the lid and the shield panel; wherein, optionally, the second rib is removably attached to the lid or the shield panel, whichever the second rib is removably attached to, by a suitable fastening arrangement, wherein the fastening arrangement is configured to prevent the first and second ribs from collapsing.

79. A lid for a beverage container, the lid comprising:
an outer side, an inner side and a rim;
a drinking aperture formed in the lid; and
a flow deflector arrangement adjacent to the drinking aperture,
wherein the lid comprises a first flap formed in the lid and initially blocking the drinking aperture.

80. The lid as claimed in claim 79, wherein the first flap is movable between open and closed positions, wherein in the closed position, the first flap is positioned across the drinking aperture and in the open position the flap is positioned perpendicular to or at an angle in relation of the plane of the drinking aperture;
optionally, wherein the flow deflector arrangement is independent from the first flap.

81. The lid as claimed in claim 79, wherein the flow deflector arrangement comprises a panel provided on the inner side of the lid underneath the first flap or on the outer side of the lid over the first flap, the panel having a second flap formed in the panel and the second flap being movable between open and closed positions, wherein in the closed position, the second flap is oriented across the drinking aperture and in the open position the second flap is positioned perpendicular to or at an angle in relation of the plane of the drinking aperture;
optionally, wherein the first and second flaps are superimposed so that when the upper one of the first and second flaps is pushed through the drinking aperture, the lower one of the first and second flaps is also pushed by the upper flap into the open position, wherein when both the first and the second flaps have been pushed downwardly into the open position, the first and second flaps remain engaged and, thereby form a shield adjacent to the drinking aperture and, simultaneously, together with the inner side of the lid, define the flow opening.

82. The lid as claimed in claim 79, wherein the flow deflector arrangement comprises a permanent shield of suitable shape and size formed on the inner side of the lid;
optionally, wherein the permanent shield is provided as an elongated trough attached to the inner side of the lid, wherein the trough has at least one open end adjacent the drinking aperture and facing sideways in relation to the inner side of the lid, i.e. towards the wall of the container in use, so as to define the flow opening together with the inner side of the lid;
optionally, wherein the flow deflector arrangement comprises a filter shield made from a liquid pervious material and arranged on the inner side of the lid across the drinking aperture, the liquid pervious material comprising pores sufficiently fine to reduce or minimise splashes, but capable of allowing liquid to flow through the drinking aperture during drinking;
optionally, wherein the liquid pervious material is capable of allowing liquid to pass through but preventing solid particles which may be dispersed in the liquid from passing through it;
optionally, wherein the filter shield has a portion downwardly spaced from the drinking aperture, i.e. away from the inner side of the lid, and peripheral portions by which the filter shield is attached to the inner side of the lid laterally spaced from the drinking aperture.

83. The lid as claimed in claim 82, wherein the first flap is movable between open and closed positions, wherein in the closed position, the first flap is positioned across the drinking aperture and in the open position the flap is positioned perpendicular to or at an angle in relation of the plane of the drinking aperture, wherein upon being pushed downwardly through the drinking aperture, the first flap forms part of the shield.

84. The lid as claimed in claim 79, wherein the flow deflector arrangement comprises a pop up shield of suitable shape and size formed on the inner side of the lid across the drinking aperture;
optionally, wherein the first flap is movable between open and closed positions, wherein in the closed position, the first flap is positioned across the drinking aperture and in the open position the flap is positioned perpendicular to or at an angle in relation of the plane of the drinking aperture, wherein the pop up shield is folded prior to use and the pop up shield is unfolded by pushing the first flap downwardly through the drinking aperture thereby expanding the pop up shield, wherein upon being pushed downwardly through the drinking aperture, the first flap forms part of the shield.

85. The lid as claimed in claim 82, wherein the permanent shield comprises a shield panel provided at the inner side of the lid spaced from the inner side of the lid;
optionally, wherein the shield panel has one or more cut-outs in the proximity of the drinking aperture so as to define the flow opening together with the inner side of the lid;
optionally, wherein the shield panel is sized and shaped to fit snugly against the wall of the beverage container in use;
optionally, wherein the shield panel is of a different shape to the rim of the container, such that when the lid closes the beverage container, the shield panel causes the wall of the beverage container to deform and to assume the shape of the shield panel.

86. The lid as claimed in claim 85, wherein the shield panel is attached to the inner side of the lid via connector elements, wherein the connector elements are also configured to act as spacers to keep the shield panel spaced from the inner side of the lid;
optionally, wherein the connector elements are arranged so as to fit snugly against and/or deform the wall of the beverage container in use;
optionally, wherein the connector elements are formed separately from the lid and shield panels and fixed to them by welding, gluing or other suitable method.

87. The lid as claimed in claim 86, wherein the connector elements are movable between expanded and collapsed states, wherein in the expanded state, the connectors project from the planes of the lid and shield panels and keep the lid and the shield panel in a fixed position spaced from each other and in the collapsed state the connector elements fold or collapse towards the lid and the shield panels whereby the shield panels are moved closer together thereby reducing or eliminating the space between the lid and the shield panel.

88. The lid as claimed in claim 87, wherein the connector elements comprise one or more ribs on each of the lid and the shield panel, wherein, on assembly, the ribs of the lid and the shield panel are configured to inter-engage so as to couple the lid and the shield panel;
optionally, wherein the lid and the shield panel are each formed from a piece of planar sheet material and folded along pre-defined lines to form the ribs;
optionally, wherein suitable cooperating slots are made in the ribs so that the ribs of the lid and those of the shield panel engage upon assembly by crossing each other via the slots;
optionally, wherein the ribs comprise a first rib attached to each of the lid and the shield panel and a second rib, wherein the second rib is attached to one of the lid and the shield panel and removably attached to the other of the lid and the shield panel; wherein, optionally, the second rib is removably attached to the lid or the shield panel, whichever the second rib is removably attached to, by a suitable fastening arrangement, wherein the fastening arrangement is configured to prevent the first and second ribs from collapsing.
